(19) United States
(12) Patent Application Publication
(10) Pub. No.: US 2020/0258483 A1
(43) Pub. Date: Aug. 13, 2020

(54) SYSTEMS AND METHODS FOR DYNAMIC MONITOR MANAGEMENT

(71) Applicant: PRINTPAK INTERNATIONAL INC., Waterloo (CA)

(72) Inventor: Donald BOEHMER, PARIS (CA)

(73) Assignee: PRINTPAK INTERNATIONAL INC.

(21) Appl. No.: 16/800,373

(22) Filed: Feb. 25, 2020

Related U.S. Application Data
(63) Continuation of application No. PCT/CA2018/051022, filed on Aug. 24, 2018.
(60) Provisional application No. 62/550,257, filed on Aug. 25, 2017.

(51) Int. Cl. G09G 5/393; G06F 3/14

(52) U.S. Cl. CPC G09G 5/393; G09G 2370/022; G06F 3/1423

(57) ABSTRACT

A system and method of updating a display device is provided. The system comprises a processor and a memory storing instructions which when executed by the processor perform the method. The method comprises detecting a change in display data stored in a database, and updating a display template file to reflect the change in the display data. The display template file comprises data fields having names that are similar to names of corresponding database data fields. The display template file are used by a local display system to render the display data.

### CROSS-REFERENCE TO RELATED APPLICATIONS

This application claims all benefit including priority to U.S. Provisional Patent Application 62/550,257, filed Aug. 25, 2017, and entitled: “Systems And Methods For Dynamic Monitor Management”, which is hereby incorporated by reference in its entirety.

### FIELD

The present disclosure generally relates to the field of digital display controllers.

### INTRODUCTION

Digital displays can deliver content to consumers. The process for updating content is a manual and time intensive process. For example, if a user wants to change content on their display, they have to contact an agency to relay their change, wait for a proof, send the proof back with updates or approval, and wait for until the agency processes the change until the updated content is live on the digital display.

### SUMMARY

In accordance with an aspect, there is provided a system for updating a display device. The system comprises a processor, and a memory storing instructions which when executed by the processor to perform a method of updating a display device. The processor is configured to detect a change in display data stored in a database, and update a display template file to reflect the change in the display data. The display template file comprises data fields having names that are similar to names of corresponding database data fields. The display template file are used by a local display system to render the display data.

In accordance with another aspect, there is provided a method of method of updating a display device. The method comprises detecting a change in display data stored in a database, and updating a display template file to reflect the change in the display data. The display template file comprises data fields having names that are similar to names of corresponding database data fields. The display template file are used by a local display system to render the display data.

In accordance with another aspect, there is provided a non-transitory computer-readable medium having instructions thereon which, when executed by a processor, perform a method of updating a display device. The method comprises detecting a change in display data stored in a database, and updating a display template file to reflect the change in the display data. The display template file comprises data fields having names that are similar to names of corresponding database data fields. The display template file are used by a local display system to render the display data.

In accordance with another aspect, there is provided a system for updating a display device. The system comprises a processor, and a memory storing instructions which when executed by the processor to perform a method of updating a display device. The processor is configured to detect a change in display data stored in a database, update a current master data sheet based on the change in the display data, determine a location of a display associated with the change in the display data, and update a display template file to reflect the change in the display data, the display template file used by a local display system to render the display data. The current master data sheet comprises data fields associated with the display data.

In accordance with another aspect, there is provided a method of method of updating a display device. The method comprises detecting a change in display data stored in a database, updating a current master data sheet based on the change in the display data, determining a location of a display associated with the change in the display data, and updating a display template file to reflect the change in the display data, the display template file used by a local display system to render the display data. The current master data sheet comprises data fields associated with the display data.

In accordance with another aspect, there is provided a non-transitory computer-readable medium having instructions thereon which, when executed by a processor, perform a method of updating a display device. The method comprises detecting a change in display data stored in a database, updating a current master data sheet based on the change in the display data, determining a location of a display associated with the change in the display data, and updating a display template file to reflect the change in the display data, the display template file used by a local display system to render the display data. The current master data sheet comprises data fields associated with the display data.

In accordance with another aspect, there is provided systems and methods for dynamic monitor management.

In accordance with another aspect, there is provided a system for controlling a plurality of display devices. The system has a dynamic template to configure an interface layout for data items. The system has a smart sheet to link data to a field using a rules engine and automatically populate the dynamic template with the data to the linked field, the rules engine having rules based on a naming convention for the plurality of display devices and the field. The system has a display controller to control the plurality of display devices in real-time to display content based on the dynamic template.

In some embodiments, the display devices are linked to a location identifier and the rules engine using the location identifier for the naming convention.

In some embodiments, the display devices are linked to a user identifier and the rules engine using the user identifier for the naming convention.

In some embodiments, the smart sheet receives updated data, determines another linked field, and automatically populates the dynamic template with the updated data to the other linked field, wherein the display controller controls the plurality of display devices in real-time to display the updated data based on the dynamic template.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates, in a component diagram, an example of a system for updating a display, in accordance with some embodiments.

FIG. 2 illustrates, in a flowchart, an example of a method of updating a display device, in accordance with some embodiments.

FIG. 3 illustrates, in a flowchart, another example of a method of updating a display device, in accordance with some embodiments.

FIG. 4 illustrates, in a schematic diagram, an example of a control platform, in accordance with some embodiments.

### DETAILED DESCRIPTION

Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

One way to drive content to the digital displays is via a comma-separated vector (CSV) sheet. One issue with this is that once any data is exported from one program, all the references on what the data represents may be limited exclusively to that program. When that condition exists, only the native program it was created in understands what the data represents.

In order to use data to drive content, a new program is taught what the data represents by manually linking each area where that data is to be populated back to a specific column and row on the CSV sheet. Once data has been linked, automation can begin. However, it is time consuming to do all this up front work, that is done on every template that is uploaded to the system.

To avoid the time consuming steps, digital display management entities have tried to integrate their software with their client's company software. This can also be expensive and time consuming since there is a reliance on capturing results from typically running queries. There are many exceptions to the rules and queries to write just to get the information, let alone look for changes and act on the changes. Many software developers do not share their proprietary code which makes this even more difficult. What seems like an easily definable project often turns into substantial wasted time and money. Software updates can also complicate the functionality and may not be easily transferable.

In some embodiments, a system may automate a process used by a single or multiple location organization to police and update the content that appears on digital displays. Such content may include, but is not limited to, menus, schedules, training material pricing, inter-company communications and advertising. One example of a multiple location organization is a quick service restaurant (QSR) chain.

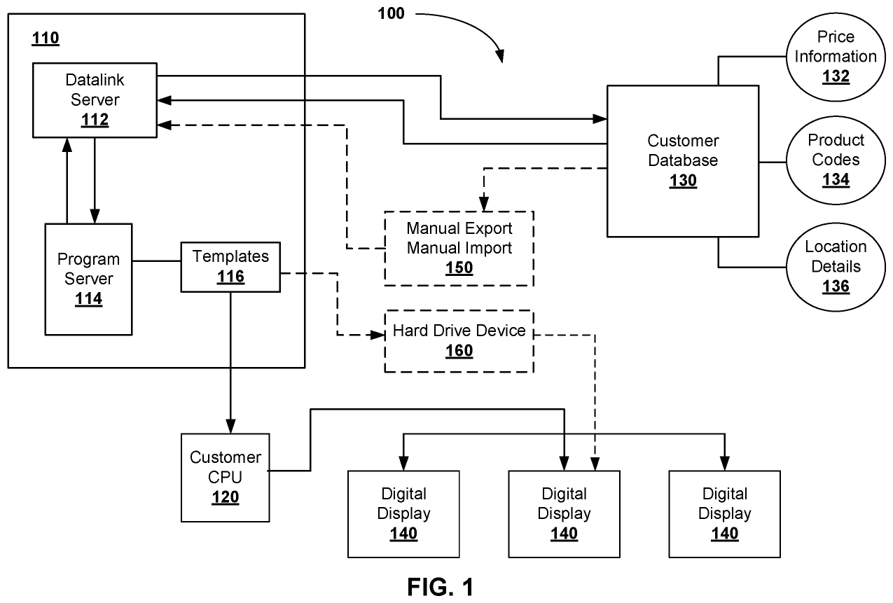

FIG. 1 illustrates, in a component diagram, an example of a system environment for updating a display 100, in accordance with some embodiments. The system 100 comprises a central display system 110, a customer central processing unit (CPU) 120, a customer database 130 and display units 140. In the description below, the terms “customer”, “client”, and “company” are used interchangeably. The CPU 120 may also include a local display system and the terms “customer CPU”, “local display system”, “local display program” may be used interchangeably with reference numeral 120. Optionally, the system environment 100 may include a manual data file unit 150, and a hard drive device 160. The central display system 110 includes a datalink server 112, a program server 114 and at least one display template 116. The datalink server 112 communicates with the customer database 130. The customer database 130 includes display information. In some embodiments, the display information may include, for example, price information 132, product codes 134 and location details 136 for a company, such as, but not limited to, a QSR. It should be understood that other display information may be stored in the database 130 for similar or different types of companies.

The customer CPU 120 may receive communication from the program server 114 to obtain display templates 116. The customer CPU 120 will see the received display templates 116 as new and push them to the display devices 140. Alternatively, the program server 114 may optionally send the display templates 116 to a hard drive device 160 (such as a raspberry pi device) to direct the displays 140 to render display data based on the display templates 116. In some embodiments, display data fields in the display templates 116 comprise the same or logically similar name as the corresponding data fields in the database 130. The manual data file unit (manual export/manual import) 150 may communicate with the datalink server 112 and the customer database 130.

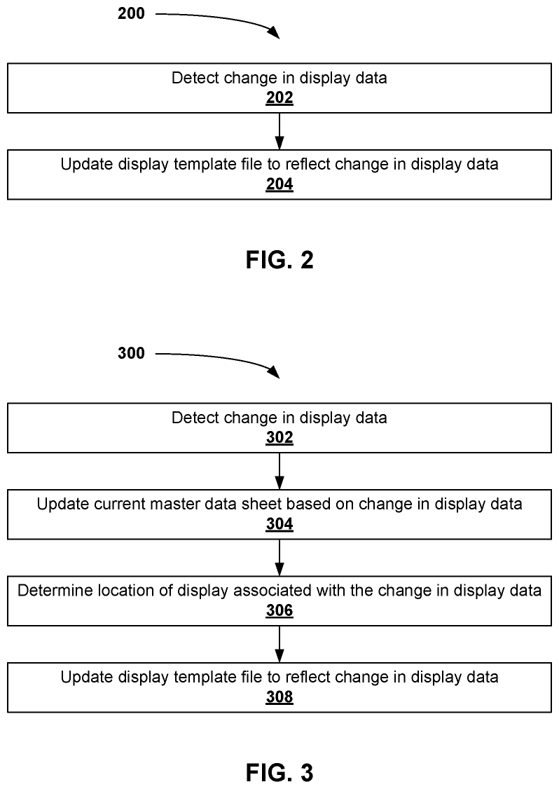

FIG. 2 illustrates, in a flowchart, an example of a method of updating a display device 200, in accordance with some embodiments. The method 200 may be performed by a processor in the central display system 110. The method 200 comprises detecting 202 a change in display data stored in a database 130. Next, a display template 116 for the display device 140 is updated 204 with the change in display data. The data fields in the template 116 have the same or logically similar names as the corresponding data fields in the database 130. As such, locating and modifying the correct data field in the template 116 may be automated by simply matching the data field names, or matching the database data field names with logically similar data template field names. It should be understood that by logically similar name, there is a name where there is a one-to-one function mapping from the database data field name to the template data field name, and this function mapping may be programmatically determined by a function call or a look-up table call. Other steps may be added to the method 200.

The example of FIG. 2 may be applied where one data sheet (i.e., the display template 116) is used to track and update changes to the database 130. In other embodiments, other data sheets (e.g., a master data sheet, such as a CSV sheet) may also be used to help with the change tracking.

FIG. 3 illustrates, in a flowchart, another example of a method of updating a display device 300, in accordance with some embodiments. The method 300 may be performed by a processor in the central display system 110. The method 300 comprises detecting 302 a change in display data stored in a database. A current master data sheet may then be updated 304 based on the change in the display data. The current master data sheet may comprise data fields associated with the display data. In some embodiments, the current master data sheet comprises data fields having names that are the same or logically similar to names of the corresponding database data fields. It should be understood that by logically similar name, there is a name where there is a one-to-one function mapping from the database data field name to the template data field name, and this function mapping may be programmatically determined by a function call or a look-up table call.

Next, a location of a display associated with the change in the display data is determined 306. The display template file is then updated 308 to reflect the change in the display data. The data fields in the template 116 have the same or logically similar names as the corresponding data fields in the database 130. The display template file may be used by a local display system to render the display data. Other steps may be added to the method 300, which will described in further detail below.

Database programs do not typically allow duplicate values to exist when describing an item, otherwise programs would not be able to differentiate a specific item from another to perform functions or tasks. In some embodiments, database items and data sheet items may be given identical names. Software logic may be configured to look for these values automatically. For example, if a matching location code 136 (unique identifier) is located, then the location of the display is known. Then a second match for this location may be located (for example, the Product Code 134). Now the location and item for the location are defined. As such, the software can then look on the same row for the exact information associated to this item for that location, and use that information to complete a task such as, but not limited to, loading a price, loading an image, loading their social media content, loading a graph and other tasks associated to the product code 134 as defined on the data sheet template 116. In some embodiments, the data sheet template may comprise a comma-separated value (CSV) sheet. For simplicity of presentation, the remaining description will refer to CSV sheets or CSV smart sheets, but the description also applies to other types of data sheets.

In some embodiments, changing the way a bounding box is named allows for an incoming CSV sheet to be understood (i.e., database 130 data fields, corresponding master data sheet data fields, and corresponding display template data fields 116 can be given the same name). Such a naming convention may be used as the basis for the program to allow for automation with minimal or no human intervention. Rather than running query after query, and having a customer's program give the results, the system 110 may go to the same place that customer's program goes for answers, which is the customer database 130. With direct access, the database 130 may be monitored for changes. If a display data item (such as a product code 134) has a value or information that has changed, the location (i.e., location details 136 for display 140) to which this change belongs is known, as well as what item has changed. Since the system templates 116 describe the items identically, where to apply this change is also known. With minimal or no human intervention, if a change on the customers database 130 is found, digital displays 140 may be automatically updated (in some embodiments in real-time) to match the company's database 130. If direct access to the database is not available, then CSV sheets (or other database data sheets) may be uploaded to the system 110, for example, via the manual data file unit 150.

In some embodiments, an opening argument (which could be a letter or number followed by an underscore to the beginning of the Product Code 134) may be added. A closing argument to the end of the code 134 may also be added by having an underscore followed by a number or letter. For example, if the product code was 12300 and it sold for $12.99, the product code maybe named “F_12300_D”. The “F_” may stand for French in order to automatically place the “$” on a price. The “_D” signifies this box loads the dollar value and then a code (such as “F_12300_C”) may be used to load the cents value. These two codes would generate a price of “12.99$”. If we remove the “F_” from the beginning of each product code, it will generate a price of “$12.99”.

As previously noted above, integrating with a digital display manufacture software (e.g., on local display system 120) can be difficult and time consuming. Such manufacturers may not share their proprietary code and any changes or updates put software solutions at risk of failure and may require extensive software revisions. Their programs may require a display data file to be uploaded into their program, and define who the display data is for and on which digital display the data should appear. An older file may also need to be deleted if a new file is replacing it. This can be a time consuming process if there are hundreds of locations.

By analyzing the CSV sheet following the naming convention described above, the file is known to the system 110. For example, the system 110 knows who it is for, what digital display it belongs to, and if it is a new file or a file with change. A digital display manufacturer system may give an each file uploaded a unique name and place them in a folder for that location that is linked to the digital display 140. Their program polls this folder for change that resides on the customer CPU 120 (e.g., the local display system). When they find change such as a new file 116 sent to the local display system 120, they react by pushing this file 116 out to the display 140. The system 110 automatically saves an updated change display template file 116 or a new display template file 116 into the same location the local digital display program would save it in the local display system 120. The local digital display program (e.g., display manufacture program) sees the changed display file 116 and pushes that file out to the display 140. Since the system 110 is in control of change and knows when it happens, the system 110 may name the display template files 116. If the file 116 is new, it may be added to the folder. If it is a file 116 with a change, the old file on the local display system 120 may be automatically deleted and replace with an updated one with another name. This triggers the local display program on local display system 120 to push the file 116 out to the display 140 automatically.

In some embodiments, where the system 110 has direct access to the database 130, the system 110 may detect a change in the display data 302 by extracting the customer data from the database 130 and populating an updated master data sheet comprising data fields with the display data stored in corresponding (and having logically similar names) data fields in the database 130. The updated master data sheet may then be compared to the current master data sheet to locate changes made in the database 130. This will be further described below. Other ways of detecting a change in the database 130 are possible.

In some embodiments, where the system 110 does not have direct access to the database 130, the system 110 may receive the updated master data sheet. This will be further described below.

In some embodiments, updating a current master data sheet 304 may comprise merging the current master data sheet with the updated master data sheet. This will be further described below.

In some embodiments, determining 306 the location of the display 140 associated with the display data change may comprise obtaining the location information 136 from a location data field associated with the change in the display data. This will be further described below.

In some embodiments, updating 308 the display template file 116 to reflect the change in display data may comprise generating an updated display template file that reflects the change in the display data, and replacing the current display template file stored at a location accessed by the local display system with the updated display template file. This will be further described below.

In some embodiments, there may be a plurality of changes pertaining to a plurality of displays 140. In such embodiments, the system 110 may determine the locations for each display 140. For each display 140, the system 110 may parse the updated master data sheet to generate a separate display template file 116 specific for that display 140. Each separate display template file 116 may include entries associated for that display. The separate display template files 116 may then be stored in a location accessed by the local display system. This will be further described below.

In some embodiments, where the system 110 locates a data field name on the display template 116 that does not have a corresponding data field name on the master data sheet, the system 110 may add a new display data field to the master data sheet for each location. The new display data field may have a name that matches the display template field name. This will be further described below.

In some embodiments, the system 110 may associate a plurality of display template files 116 with a display 140 of the local display system. Each display template file 116 may be associated with and rendered on the display 116 by the local display system during a display time. This will be further described below.

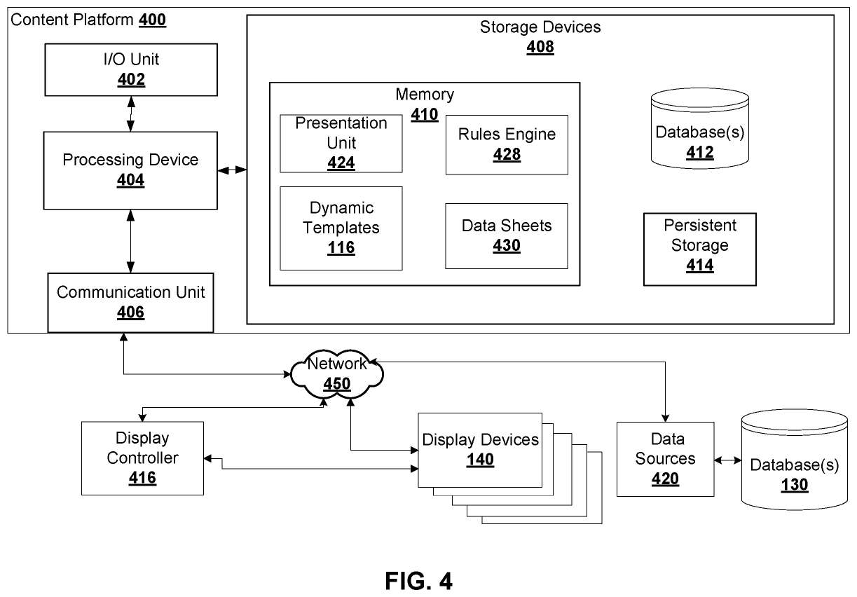

FIG. 4 illustrates, in a schematic diagram, an example of a content platform 400, in accordance with some embodiments. The content platform may implement the system 110 for updating a display 140. The content platform 400 includes an input/output (I/O) unit 402, a processing device 404, a communications unit 406 and a storage device 408. The processing device 404 may perform the method 200, 300. The storage device 408 can include databases 412, persistent storage 414, and memory 410. The content platform 400 can connect to a display controller 416, display devices 140 and data sources 420. In some embodiments, the display controller may be the local display system. In some embodiments, the data sources 420 may be the manual data unit 150 or a direct connection to the customer database 130. The memory 410 can include instructions executable by the processing device 404 to configure a presentation unit 424, dynamic templates 116, rules engines 428 and data sheets 430. In some embodiments, the data sheets 430 comprise master data sheets and/or CSV sheets or smart sheets. Data sources 420 can relate to specific users (and linked to a user identifier) and products. Data sources 420 can include QSR information, airport information, financial information, pricing information, loyalty programs, and so on.

In some embodiments, the presentation unit 424 connects with display controller 416 to generate and update content for display devices 140 (e.g., content interfaces) with visual elements and receive control comments. In some embodiments, this entails the platform 400 sending templates 116 to the display controller 416. The display device 140 displays content for viewing by consumers. The content can be displayed according to a template linked to one or more dynamic templates 116. The content and updates for the content can be received from data sources 420 and/or stored in storage device 408. In some embodiments, the presentation unit 424 generates an interface for display devices 140 and the display controller 416 controls the interface at display devices 140 in order to update content. The interface has visual elements corresponding to content and the dynamic templates 116.

The content platform 400 has the ability to take in data for content updates and apply it to the display devices 140 in real-time. The content platform 400 can assign a value to a field to populate data into a template 116 so it appears on the display device 140. The content platform 400 can take advantage of naming conventions, as described herein. The content platform 400 names the field with updated content the same (or logically similar) name every time so that it understands what the field is are describing and what to do with it. Companies that offer display devices 140 provide unique names to data fields that describes the data on the data sheet to know what the fields represent when reading it, e.g., coupons code 30254. Rather than having one data sheet driving each template 116, the content platform 400 may compile a master database of data files 430 (e.g., a master database of CVS smart sheets) full of unique field names like Coupon code 30254. This continually grows and learns as each database is imported into the content platform 400. The content platform 400 can track individual display device 140 locations by uniquely naming them (e.g., assigning a unique display device identifier linked to a location identifier). The content platform 400 assigns each location a complete duplicate list of all field names like Coupon code 30254. This grows per location as more database sheets are imported in the CVS smart sheets (i.e., data sheets 430). The content platform 400 is able to identify each location, assign unique values or images based on a name to any fields that exist on a dynamic template 116 with the same field name on a per location basis. This opens this up to a whole new level of automation. Now a master chain (e.g., user of content platform 400) can provide a new database as often as they wish that the content platform 400 can populate data on a per location basses per field basis and go live to the display devices 140 instantly with each location displaying the desired content accurately. The content platform 400 provides instant results in real-time with no human intervention.

Dynamic templates 116 can identify locations for content data items to be displayed on display devices 140. CVS smart sheets (e.g., data files 430) include unique field names for content data items which are linked to display devices 140 and user identifiers. Rules engine 428 provides code logic to automatically update CVS smart sheets (e.g., data files 430) with incoming sheets.

The content system 400 is configured to link a CSV field (e.g., column and row) of a CVS smart sheet 430 to a template field of a dynamic (display) template 116 to automate content updates for a digital display 140 and display controller 416.

The content system 110, 400 uses master CSV smart sheets 430 for content updates for display. In some embodiments, the content relates to products identified by product code 134. The content system 110, 400 can extract data from incoming CSV sheets, automatically organize the data by location and product code per location and engages rules engine 428 to choose which data populates the smart master CSV sheets 430.

The content system 110, 400 can identify a location precisely, identify and track products precisely, and automatically make the correct choice to use stored information or incoming information to populate dynamic (display) templates 116 accurately. The CSV smart sheets 430 include data on precisely how to populate a dynamic template 116, name a produced file and the storage location on where to store the named files so that they automatically appear on the correct display device 140. The act of the content system 110, 400 precisely placing a file in an exact location (at system 120) with an exact name is what allows the final file to be automatically pushed out to the correct display device 140 by taking advantage of the third party software's automation. The content system 110, 400 places the revised file in the exact same location, in the exact same folder on the same server where other programs would place it upon upload. This mimics the act of someone manually uploading a file and does not break the flow of automation. Other programs automatically take over processing the file once the content system 110, 400 places the revised file in the correct location since the appearance of change in a folder is what triggers other software to act. This solution might not require any code integration between parties and still allows the user to maintain the features their current program offers while using the content system 110, 400 to automate the editing of dynamic templates 116 so they automatically appear in real time as desired on individual display devices 140.

The content system 110, 400 can use a reverse look-up process for a match. Thus, an agency or a company no longer has to extract the matching data out of a master database and create a custom CSV sheet per template. The content system 110, 400 can do a complete dump of all data, import the data, and use the rules engine 428 to map the data to CVS smart sheets 430 and dynamic templates 116. The content system 100 can organize the data and finds what its needs instead of the user finding what the content system 110, 400 needs. This provides time savings and organization.

Having a generic item like a video appear in every playlist based on day parting can use a tremendous amount of disc space storing a copy of it in each monitors folder and in each playlist folder. With this method, the content system 110, 400 can push out an item automatically, and dynamically.

Placing totally new content on all display devices 140 can take a tremendous amount of time. The agency needs to lookup each stores pricing for each slide they may want in a playlist, typeset it, send it off for proofing, track corrections and then place the approved file(s) the correct locations folder that will make it appear on their monitor and hope this was done correctly. The content system 110, 400 can push out this new content automatically and in real-time.

Without the system 110, 400, content updates are normally handled by an agency due to the complexity and manual process. Manually managing displays for a large chain may be incredibly time consuming and requires a full staff. It is open to error and does not allow them to react to market conditions in a timely manner. The only way to speed up reaction time is to add more staff which can become cost prohibitive.

Every template can require the agency representing a company, or the company, to extract the data out of a master database and create a CSV sheet with only the product codes that appear on the sheet. The content system 110, 400 can create dynamic templates 116 and CVS smart sheets 430 automatically and in real-time.

Display customers tend to invest in digital displays and they only operate with that manufacture's software. For example, a Sony display may not be operated with Samsung software. The customer may be tied to a manufactures device if it is too cost prohibitive to change. One hardware supplier may have a cheaper monthly software license, but it will not work with another leaving the customer trapped into using the services of the hardware provider. Some customers may not want to purchase an expensive display with an internal hard drive but instead purchase a cheap smart display. The manufacturer has no ability to communicate with them or push content out to them.

Each manufacturer can have their own proprietary software that only works with their display devices. Essentially this locks users into the manufacturer and makes it very costly for change. This makes gaining new business extremely difficult when the customer has already invested heavily into the monitors. They do not want endure his expense again limiting the business companies can go after. The content system 110, 400 can integrate with different third party local display software residing on system 120.

The system 110, 400 may communicate directly with any digital display 140 having the ability to play content from an external device. Typically, this is done via HDMI cable, but is not limited to this. In some embodiments, the system 110, 400 may communicate with a device, such as raspberry pi device, to render the display template files 116 on the display 140. Any such device would preferably have a video player, internet capability, be multifunctional, and can be bought with a variety of hard drive capacities. By communicating directly with such a device over an Internet connection, content may be pushed for identical results to the manufactures software.

The display controller 416 interacts with templates 116 received from content platform 400 to link data to a field and automatically populate that data to a matching field. By contrast, in the previous manual process, a person has to physically tell a program what field belongs to what column off the CSV sheet (e.g., row 1 column B populates this field). It may be by drag and drop or other methods to achieve. The content platform 110, 400 automates this process by taking advantage of a naming convention.

The content platform 110, 400 can create a template 116 and master data sheet 430 having display data associated with data in the database 130. The content platform 110, 400 can name fields in the master data sheet 430 using the same name as the product code 134 on the template 116. The rules engine 128 may look for a matching name on the CSV sheet 430 and the template 116. When it finds a match, the content platform 110, 400 automatically links the data to this field with no other human intervention. This allows for automation. Now the customer's system (e.g., local display system) and the content platform 110, 400 are describing the product using the same naming convention. Rather than a single CSV sheet driving a single template 116, the content platform 110, 400 may use a master CSV smart sheets 430 to drive dynamic templates 116. Upon upload of database 130 data, the content platform 110, 400 breaks the information down automatically by location, and looks in the master data sheet for an existing product code 134 by location. If the content platform 110, 400 finds a matching product code 134, it either does nothing if no change is present, or updates the data in the master data sheet 430 if a change is present. If the content platform 100 does not find a matching product code, then the content platform 100 adds it to the master data sheet 430 for each location. This can further the automation.

The dynamic templates 116 can refer to a single master CVS smart sheet 430 for instructions. The content platform 110, 400 can track changes on this CVS smart sheet 430. If a change is present, the content platform 110, 400 automatically updates every instance on dynamic templates 116 instantly. No longer does a human have to go in and look for all templates that contain that product code per location and manually update them one by one. When the content platform 110, 400 applies the changes, it creates a new content item (e.g., PDF or JPEG) and places it in the correct locations folder (at system 120) for the correct display device(s) 140 if the location has more than one. Most manufacture's software uses polling to look for change. The content platform 110, 400 file has a new creation date so the manufacture's program sees it as change and sends the new file out to the display device 140. The content platform 110, 400 also has the ability to bypass the manufactures software and communicate directly with the display device 140 via device 160. The content platform 110, 400 can create content items such as static images, new videos or playlists with the revised files that will play on the desired display device 140.

Prior to the system 110, 400, when reacting to market conditions, in order to push content out to the displays, each location's new copy is typeset, saved as the type of file used for the application, uploaded to the manufactures program, and it is determined if the new copy replaces an old file or is a new file. There is no fast way to do this; it takes several full time staff weeks to complete this task and is very error prone.

The system 110, 400 utilizes the approach defined above to update display data. In some embodiments, all possible templates 116 in various languages for the entire organization may be uploaded at once. The system 110, 400 may be configured to search for what products a location sells and compare them to each template 116. If no match is found for a template 116, then that template 116 is not used for that location. A customer profile may be setup for language preferences in different locations. Then, only templates 116 using the language preferences are pushed to that location. Finally when all decisions are made regarding which devices 140 gets what display data, any desired file may be generated such as, but not limited to, JPEGs, PDFs or MP4s. The naming convention described above may be used. Optionally, preparation may be made in advance, and a time may be set for a rendering to execute at the set time.

Without the system 110, 400, taking requests from each location of an enterprise for changes or additions to the display consumes a significant amount of time, and is performed during business hours or when a person is available on call. The request need be understood and manually performed. Proofs may be sent out for review, corrections made if needed, and finally the files are uploaded into a manufacture program.

Manufacture software does not typically have the ability to police brand rules, nor the ability for locations to push content out to the digital display without direct access to their software. This would require each location to have extensive training, typeset each template from scratch, and open the door to unwanted changes in the software, which may render this desirable function unattainable.

A location user can require a change on their display device 140 to update content. It is time consuming and expensive to contact the agency to relay their change, wait for a proof, send the proof back and wait for until the agency processes the change so it becomes live. The content system 110, 400 can make this update in real-time automatically.

Further, a user may find an error such as spelling mistake, wrong code or image after desired content is live on all display devices 140 across the country can take a crew of people a tremendous amount of time to correct using a manual process. They have to go into every locations art, update, save it and place it in the correct folder so the existing program sends it out to the correct display device 140. If they place the wrong art or content in the wrong folder or forget to make a change, the content will appear on the screen wrong. This manual process is time consuming. The content system 110, 400 can correct these errors automatically.

A user may want to push out content for a limited time promotion to appear on each location's display devices 140 can require the agency handling the account to typeset an individual ad for each location and manually place it in the correct folder to make it live on the desired monitor or display device 140. This is time consuming and open to error. The content system 110, 400 can push out this promotion automatically and in real-time.

In some embodiments, the content platform 110, 400 may optionally allow each user location to access the dynamic templates 116 that have sections configured to receive data. The content platform 110, 400 may allow them to edit information on them by changing a price, using a different image and so on. The content platform 110, 400 may allow them to create and schedule the timing of playlists with these edited templates. They may want to run a custom lunch or dinner special only for their location. Their login tells content platform 110, 400 who they are by way of a user identifier and/or location identifier. The content platform 110, 400 may allow a policing feature that limits on a per location basis the templates 116 they can edit. The content platform 110, 400 may allow a limit for the capabilities on a per offer basis to include things like price range, images, if they can type freely or limit offers used.

Optionally, the system 110, 400 may be configured to allow each location to access to the templates 116. Head office or an agency may upload all possible templates 116 that can be used or edited on the displays. For the location to access them, there may be a login access to a website to determine who the request is for. The login access may limit template access to templates that pertain to the location that is logged in. Users at a location may create playlists that appear on their displays 140. They may choose the template 116 they want added and click on them to add. The system 110, 400 typesets the templates 116. The templates 116 may be edited and saved. Once all templates 116 they want to promote are added, the location may set the times they want the templates 116 to play, such as a Lunch Special. This is commonly referred to as Day Parting. When the time comes for this playlist to play, the contents in the manufactures folder that controls the content to the display 140 may be deleted and replaced with this content.

Based on the naming convention described above, the template 116 gets pushed out to the display 140 at the set time. When the time comes to end the playlist (e.g., at a set time), the template 116 is replaced with a default playlist or, to continue the meal example, a dinner playlist. If an error is found (for example, of a price), a location user may login to a system 110, 400 website, open the problematic template 116, make the change and save it. The corrected version will appear automatically. The system 110, 400 may also employ built-in safeties that control the brand as well as provide data range limits. For example, images, fonts, and colours may be limited to a pre-set customer brand selection, and a price spread may be limited on each individual offer by location or location type. Customer rules may be policed automatically. In some embodiments, a location is able to complete their change needs on their display 140 in under two minutes, which is faster than relaying their needs to another person. Moreover, the changes can be performed 24/7.

The content platform 110, 400 can automate the process required by multiple location chains to police and update the content that appears on their display devices 140 they use in house to display things like menus, schedules, advertising, and so on. The issue that has eluded major manufactures of digital monitor display devices 140 is allowing the end user where the display device 140 physically exists to make their own changes and have them appear on the correct display device 140 in real-time with no other human intervention. The content platform 110, 400 provides a solution with automation of common tasks that currently take hours to preform and turn content updates into a click of a button to provide the content to the content platform 110, 400 as a data source 420.

In some embodiments, a head office may be permitted to add their content to each display using a customer profile, as described herein. If a location is promoting the same item as a head office, a location specific template may be replaced with a generic head office template version to ensure there is no conflicting information. As soon as the head offices template version expires, the location template version may be reinstated. All copy plays seamlessly as if it was all created as a single playlist. This provides head office freedom to push whatever content they want out, and the individual location freedom to display whatever they want while minimizing any chance for error or inconsistency in an efficient manner.

In some embodiments, the content platform 110, 400 assists the governing body to enforce the rules while allowing freedom. When the location opens a template 116, it populates all values from a master CSV sheet 430 to matching fields on any given template 116. They make their changes which update the master CSV smart sheet 430, the content platform 110, 400 gives them instant proofs, makes them sign off on them, allows them to set the times this appears and ends on the display devices 140, and allows them to view what the display device 140 will look or play like before making it live. They can do this by connecting to content platform 110, 400 from any smart device from anywhere in the world. To ensure continuity, if a location makes a price or image change on a product (e.g., Large Fries), no matter what display device 140 or playlist that belongs to the location where the product appears on it, every single instance of this will be updated immediately after making this instance live so no matter where customers look, they will see continuity.

Some large corporations do national print campaigns. To typeset each location, track changes, produce final press ready files, order quantity and track shipping, as well as special requests is a full time job. If an error is found on the copy come press time, it could take days to correct and recreate the files resulting is a missed deadline.

The content platform 110, 400 allows the templates 116 to be tied into the print ordering program. The print ordering program may be run off the same master CSV sheet 430. If they log onto the site and go set a flyer, when they open the template 116, it automatically sets all fields off the master CSV sheet 430 including that location's information like social media address, phone numbers and address to name a few. If they make a change to a price, the content platform 110, 400 can set it so the display 140 will match the price on the printed material automatically. It can be set to do this immediately or on the date the promotion starts. They can set an end date when the promotion ends and the program remembers the pre-promotion value and it automatically reverts back to regular price on that date with no other human intervention. This timing can be tied into social media. A user can run a limited time offer on social platform when the customer comes into the location, the display device 140 can match the local media offer.

The system 110, 400 may upload all versions of the item everyone gets and each location may login to proof their copy. The program can limit each location to see only the version you want them to see. Once the location opens the template 116, the template 116 can be automatically typeset. What each location can change may be defined, and values per offer may be limited. The system 110, 400 may be tracked to determine who has and has not logged on to do this, and send automatic reminders.

In some embodiments, a minimum quantity can be faced per location and this quantity this can vary based on location type. As soon as the location places a display order, an order conformation, as well as a low resolution proof for their files, may be sent. Extras may be bought or ordered for free. In some embodiments, if locations have not logged in to complete this, a customer may have choices. One option is to selecting a “set all unordered stores” option and use a min quantity order. This will automatically typeset each store from the database and create orders for them. Each location will receive a confirmation email that this was done, along with a low resolution proof. Another option is not to produce them. Based on what is chosen, a complete report of the entire process for production may be provided. Come press time, if an error is noticed, a corrected version need simply be loaded as described above and press the update all previous orders button.

In some embodiments, the program will automatically typeset all copy over and produce print ready files quickly (in some embodiments in under 30 seconds) overwriting old ones so there is no mix-up. A unique process for this for speed and efficiency may be used. For example, a display version may be used for static templates. For anything that changes, a solid Pantone Colour in high resolution may be used. Once the file is submitted, the static four colour process portion of the file may be deleted and merged onto a high resolution version stored on the server to create the press ready file. It is not unusual for a large flyer to be over 80 MB. This would take a substantial amount of time to render. However, in some embodiments, the system 110, 400 may have the file being closer to 2 MB for superior speeds.

In some embodiments, the system 110, 400 may be tied into a courier's system to automatically generate a pending shipping request along with smart 2-D barcodes. This automatically appears in a hot folder for print in production. As soon as the carton or skid cage is scanned in shipping, it automatically changes the pending to a pickup request. All special notes are attached to the barcode and come up for the driver. This can also be tied to the customer's inventory system by including that information into the barcode so they can be scanned into a location in their shipping and it will update their system.

There should be continuity of information in hard print along with digital displays. It is not uncommon for someone to walk into a location with a flyer and find that the flyer has a different price than what is on the digital display. Determining which one is correct can sometimes be difficult, time consuming and costly.

The system 110, 400 may be used to create templates 116 for locations to order. In some embodiments, templates 116 that pertain to the location are shown, and content and brand standards are policed. The templates 116 may be automatically typeset with up to the second information when clicked on. In some embodiments, if a price is set on the hard print for an item that appears on a location's digital display, once the location submits the order, the price on the display can be changed immediately, no matter where it appears. As described above, a timing feature may also be used. If the location is running a limited time sale, the location can preset the date that the prices should change to reflect this sale. When the sale ends, the prices can be changed back to the price in the database 130.

In some embodiments, the content platform 110, 400 provides the end location users with the tools to do their own work. With the auto population of data to a template 116 by content platform 110, 400 and the ease of which the content platform 110, 400 allow changes. In some cases, it is quicker for them to make a change than it would be to pick up the phone and explain the change to another person.

The following provide examples of automation and time saving or features by content platform 110, 400. The content platform 110, 400 allows for correcting mistakes or updating new content across the country is done in seconds not days. The content platform 110, 400 enables an upload to one master template(s), clicks on apply to all and the program automatically updates every locations display devices 140 in real time. The content platform 110, 400 may be used to set prices, choose the correct images, match languages or store types and push them out to all stores at a click of a button. No other human intervention is required and no need for a full time staff to do this.

In some embodiments, the content platform 110, 400 provides the ability to react to market conditions in minutes not days by allowing the entire country to be updated as fast as the graphics can be created and uploaded to the program. The content platform 110, 400 can receive a “apply to all” command and every location's art may be instantly updated to contain all their pertinent information and made live on their display devices 140 as fast as the network 450 connections can send the new file.

In some embodiments, the content platform 110, 400 may save disc space by incorporating symlinks. Manufacturer's programs require a copy of a video in every locations folder if one is used per location. With video files typically being in the hundreds of MB in size and a symlink representing them only being 2 kilobytes in size, the disc space savings adds up quite quickly.

With the printing addition add-on, if a chain is doing a national print run and right before press time the user finds an error in the copy, the user can upload the corrected master template to the content platform 110, 400 and press an “Apply to All Previous” button, in some embodiments. Thus, the content platform 110, 400 can rest all orders placed with any new additions or changes and place print ready PDFs neatly organize by language, version and name the file by location.

Price increases across the nation can involve exporting a CSV sheet from the software that drives the cash register and importing the sheet into the content platform. The Smart CSV sheet 430 detects the change and where the change is present it triggers the display controller 416 to update the display devices 140 automatically.

The content platform 110, 400 does not require a unique CSV sheet 430 specific to each template 116 since the content platform 110, 400 is doing the reverse by looking for a match. The customer can do a dump of their entire database 130 and upload the entire database to the platform 400. The content platform 400 will look for a mating field to a template 116 saving time by creating individual CSV sheets 430 and matching them to templates 116.

In some embodiments, the content platform 400 has the ability to communicate direct with any display device 140 independent of the manufactures software. The system 110, 400 may integrate with all manufacture's software if a company is under contract. This allows an agency to go after any business in the marketplace without requiring the company they are trying to sell to purchase new display devices 140 that were previously not compatible with their software. The amount of people required at an agency to look after a large account may be reduced due to the automation.

In some embodiments, the content platform 400 has a server and is the main control device that houses the main program and a database 412 program such as MySQL. The content platform 400 can also have, for example, a program called PDFlib in some embodiments. The following paragraphs describe a specific embodiment that may be encoded using PDFlib by way of example. It should be understood that other programs may be used instead of PDFlib.

In some embodiments, the database 412 drives the program and the logic flow. In some embodiments, the CVS smart sheets 430 use 4 columns on a CSV sheet 430 (e.g., Store number, code number, value, description). It should be understood that the use of 4 columns is by way of example and that the system 110, 400 can read and use many (virtually unlimited amount of) columns. The content platform 400 has an automated way to access the customer database 130 and export data which requires no code integration into their system solving an issue of compatible code and keeping it current with updates. The content platform 400 then looks for and extracts those 4 columns from that exported data. The content platform 400 merges the extracted CSV sheet 430 with the existing CSV sheet 430 in the program and does a duplicate check. Instances of duplicate where all 4 columns match are removed leaving only store numbers who have changed values as a “refined CSV sheet” as part of the CVS smart sheets 430. The content platform 400 then imports this refined CSV sheet 430 into the programs database 412 and instructs it to overwrite only the Value and description column with the matching store and code numbers used to define what is changed. The content platform 400 uses this refined CSV sheet 430 to look for all the stores on this sheet that have the code numbers that changed in use for any of their templates 116. If the content platform 400 finds one in use, then the content platform 400 updates the template 116 with the revised value automatically and places this revised file into a hot folder that is linked to that customer number display device 140 so it will appear live on it reflecting the new data. The content platform 400 loads the data dynamically when a template 116 is opened so if the description is changed, the new description will appear on the template 116 next time it is opened to edit. That is, this field is used to provide a common way to describe an item that is to be edited.

In some embodiments, a document (e.g., PDF) may be prepped with PDFlib or similar program that can be referred to as PDFlib. If there are ten areas of change required on the PDF template, then the content platform 400 has ten PDFlib boxes. Each box defines how to interpret the data such as a text field with font colour size and style, load a PDF, and so on along with rules on how it reacts within the boundaries of the box or boxes if linked. Automation may take place by naming this PDFlib box the same name as this identical item is named in the database 130. A company can use a code number with a description within their database 130 system to define the item. If they give a code # DU1256 and a description of 1 large pizza, then the content platform 400 can use the Code # DU1256 to name the PDFlib box.

Other approaches operate in the reverse, which is time consuming and manual. They search the imported database system for header names and then they ask the user to define what each header represents. If a change is made, every header is redefined before automation can start. In contrast, the content platform 400 looks for a match. A match triggers the instructions set out in the PDFlib box to execute no matter what has changed. The store number drives what is populated to the PDFlib boxes. The client is mandated to login as their store number along with a password. This defines who wants to edit a template 116 and triggers the program to populate the information on the main database sheet 430 onto their template 116. For example, the database 130 and smart sheet 430 has store 10200 with the code DU1256 with a value of $12.99. If one of the PDFlib boxes name is code number DU1256 and this code # exists on this template 116, it will populate that field with $12.99 if the instructions of this box dictate it to load text. It repeats this process for the other nine PDFlib boxes on this template dynamically as the template 116 is opened. This ensures everything the client sees is current and updated.

In some embodiments, the content platform 400 may define and break store numbers down into groups such as A, B or C but not limed to. When uploading a template 116 to the program, content platform 400 allows the administrator to limit the values made available per PDFlib box to that group. The content platform 400 by default may populate each dropdown from 0-99 as if there were no limits. Now if a store is to be limited to enforce prices used based on group, the content platform 400 may define the range made available in an individual PDFlib box when uploading the template 116 to the program to, for example 7 to 9 for group A, 5 to 12 for group B and 4 to 15 for group C. If store 10200 is defined as belonging to group B, they will only have the dropdown that is being policed show the range of 5 to 12. This enforces continuity across the nation for a national offer, for example.

In some embodiments, the content platform 400 houses a folder on the server called Assets. If a PDFlib box is set to load a PDF into it instead of text, the program looks to this folder called assets and looks for a folder inside of this named with a code number that matches the code number the PDFlib box was named. It automatically loads all PDF's that reside in this folder as choices from a dropdown that consumers can pick from to use on their template 116. It names each item in the dropdown the same name as what the PDF is called. If they choose the third PDF in the list of drop downs, the content platform 400 tracks this with a 3 in the value column on the master CSV sheet 430. Now anytime a PDFlib box is used as part of a template with this code number, we load the third PDF in the list. The content platform 400 can also limit what PDFs are made available to each store type the same as was done with prices.

In some embodiments, the content platform 400 has a monitor program that uses the same automation. A store logs in and all fields are dynamically loaded and policed is set by admin. The content platform 400 allows the customer to choose as many temples 116 they want to edit to create a playlist. The content platform 400 sets global guidelines as instructed by head office on how the monitor reacts. The content platform 400 can allow it to be a day parting display device 140 where they can preschedule playlists they created to play at specific times of the day on certain days of the week or it can be forced to only be single playlist. The customer creates a playlist, saves it and then publishes the playlist. The content platform 400 has the program place this playlist in a hot folder that automatically detects change. When change is detected, the program sends the playlist to the defined IP address this monitor is linked to making it become live. By contrast, current approaches would require a person to create this playlist for this customer, send it out for approval, go into a monitor program, search for this store, search for the correct monitor and manually place this file in the folder.

In some embodiments, the content platform 400 allows head office “Admin” to create a playlist of their own that they can force onto all stores specific display devices 140. The automation saves time. All the admin has to do is upload every possible template 116 and define who sees it on upload to cover off every store type such as stores that do not sell pop, or stores that do not sell XL pizzas along with all language templates and schedule a start date. Come the start date, the program will look at every location to see how they are defined such as stores that do not sell pop, stores that do not sell XL pizzas, what language they use and only include the templates that pertain to their location, typeset them based on PDFlib names and place this playlist in every stores correct hot folder linked to their monitor with no other human intervention. The program will also look for identical template names used in the locations playlist they created, remove it and make the admin version trump. Then it plays this playlist in conjunction with the locations playlist. Come the expiration date of the national playlist, the program will replace any templates that were removed by the program with no human intervention. This allows Admin to react to market conditions in minutes. By contrast, the current approach may require a full-time staff having to go into every template, typeset the locations prices manually, check to see if they have a common template in use, remove that item, get approval and place this playlist in the appropriate folder. On a chain with 400 locations this would take months to react too. The content platform 400 has no limit on the number of stores that it can react to in minutes. The content platform 400 just adds more processing power to maintain this reaction time.

In some embodiments, the content platform 400 has a main server to house the program and this is where it stores the data and images. The content platform 400 uploads a template 116 to the program and it uses rules set in admin to decide who sees it such English, no pop, and so on. The content platform 400 enables a customer to edit a template 116 and pushes a publish button that has the program places it in a hot folder on the server. The hot folder has instructions on what IP address it sends the produced file to which is a specific monitor 140. The customer opens a template and the program accesses stored database 412 for values as well as second database that describes the customer such as language, group A, No pop and so on and then decides what they see and how to populate data.

In some embodiments, the content platform 400 does not have to incorporate its code with a third party code. Instead the content platform 400 can place the file in a non-hot folder and use a program (e.g., R-sync but not limited to this program) to place the playlist wanted into a folder on their server as if their program had done it. Essentially the content platform 400 has tricked the third party program to take full advantage of the rest of their software automation. They can run a polling program that looks at every folder on this location for their server for change. If their program finds change, it applies all the rules set out in their program and sends the file out to the monitor based on where this folder instructs it to send as if you had used their program completely to do this. The content platform 400 can use R-sync to look at their server for change. If the platform file does not match the third party file, then the platform file is considered trump and it replaces the folders contents with the platform content which would be the newest file created by the customer or admin.

In some embodiments, a feature to precision target customers of the locations may be employed. The database can be searched for any categories such as, but not limited to, new customers, customers you have not seen in 30, 60 or 90 days. The location logs into the website and clicks on this page for Mailings. This gives them a complete list of how many customers that are in each category that are available to mail to. If they own or are in charge of multiple locations, it shows all their locations stats in a chart like format. If they want to target the new customers as an example, they click on that category choose how many of those customers they want to target, set their offer and press submit, pay for this and they are done. The program will create a press ready file for however many that is required for the printer being used to produce them with each position on the sheet having a unique customers address.

In some embodiments, what each customers offer can be refined. For example, say you were targeting a customer you had not seen in 90 days for a Pizza Store. If they normally order a vegetarian pizza, rather than generically targeting all 90 day customers with a Meat Lovers pizza to entice them back, the offer can be suited towards the customer's buying habits for a much higher return on investment (ROI). Each customer may receive a unique offer tailored to their buying habits. The location just puts in the discount they want across the board (for example, 30%) and the program will use the targeted item they buy and discount the price that is their regular retail price automatically. In some embodiments, if there is more than one location, a box “Apply to All” may be selected and the system will automatically complete all locations instantly. For mailings that require 2-D barcodes to qualify for lower rates, these can be generated instantly as well. Mailing lists, such as but not limited to hotels, motels Inns etc., may be imported. For example, pizza places deliver to these address regularly, but it would be a waste of money to target a room number at the hotel so these addresses are removed from the database based on the import. The location may also remove addresses from the database permanently. The system 110, 400 may be further configured to track who has been mailed, and can limit how often to target customers. For example, if a customer is mailed this week, then they can be remove them from the list for 30 days. Come the 30 day mark, that customer is automatically back into the database 130.

Once the above described approach to data management is implemented, there is much potential for automation and change. The solution interacts seamlessly with virtually every existing available program. The output is not limited to digital displays but applies easily to all data representations.

The processing device 404 may be, for example, any type of general-purpose microprocessor or microcontroller, a digital signal processing (DSP) processor, an integrated circuit, a field programmable gate array (FPGA), a reconfigurable processor, or any combination thereof.

The storage device 408 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

The I/O unit 402 enables content platform 400 to interconnect with one or more input devices, such as a keyboard, mouse, camera, touch screen and a microphone, or with one or more output devices such as a display screen and a speaker.

The communications unit 406 enables content platform 400 to communicate with other components, to exchange data with other components, to access and connect to network resources, to serve applications, and perform other computing applications by connecting to a network (or multiple networks) capable of carrying data.

The content platform 400 is operable to register and authenticate users (using a login, unique identifier, and password for example) prior to providing access to applications, a local network, network resources, other networks and network security devices. A user identifier can be linked to one or more dynamic templates 116 and content, for example.

The content platform 400 connects to other components in various ways including directly coupled and indirectly coupled via the network. Network 450 (or multiple networks) is capable of carrying data and can involve wired connections, wireless connections, or a combination thereof. Network 450 may involve different network communication technologies, standards and protocols, such as for example.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. A system comprising:
a processor; and
a memory storing instructions which when executed by the processor perform a method of updating a display device, the processor configured to:
detect a change in display data stored in a database; and
update a display template file to reflect the change in the display data, the display template file comprising data fields having names that are similar to names of corresponding database data fields, the display template file used by a local display system to render the display data.

2. The system as claimed in claim 1, wherein the processor is further configured to:
update a current master data sheet based on the change in the display data, the current master data sheet comprising data fields associated with the display data; and
determine a location of a display associated with the change in the display data.

3. The system as claimed in claim 2, wherein the current master data sheet comprises data fields having names that are similar to names of corresponding database data fields.

4. The system as claimed in claim 2, wherein to detect the change in the display data stored in the database, the processor is configured to:
populate an updated master data sheet with the display data stored in the database; and
compare the updated master data sheet with a current master data sheet.

5. The system as claimed in claim 2, wherein to update the current master data sheet, the processor is configured to:
merge the current master data sheet with the updated master data sheet.

6. The system as claimed in claim 2, wherein to determine the location of the display associated with the change in the display data, the processor is configured to:
obtain the location from a display location field associated with the change in the display data.

7. The system as claimed in claim 2, wherein to update the display template file to reflect the change in the display data, the processor is configured to:
generate an updated display template file reflecting the change in the display data; and
replace a current display template file stored at a location accessed by the local display system with the updated display template file.

8. The system as claimed in claim 2, wherein the change to the display data comprises a plurality of changes pertaining to a plurality of displays, and the processor is further configured to:
determine locations for each of the plurality of displays; and
for each display, parse the updated master data sheet to include entries associated for that display in a separate display template file.

9. The system as claimed in claim 2, wherein to detect a change in a display data, the processor is configured to:
receive an updated master data sheet that reflects the change to the display data.

10. The system as claimed in claim 2, wherein the processor is further configured to:
locate a display template field name that does not have a corresponding master data sheet field name; and
add a new display data field to the master data sheet for each location, the new display data field having a name that matches the display template field name.

11. The system as claimed in claim 2, wherein the processor is further configured to:
associate a plurality of display template files with a display of the local display system, each display template file associated with, and rendered on the display, by the local display system during a display time.

12. A method of updating a display device, the method comprising:
detecting a change in display data stored in a database; and
updating a display template file to reflect the change in the display data, the display template file comprising data fields having names that are similar to names of corresponding database data fields, the display template file used by a local display system to render the display data.

13. The method as claimed in claim 12, further comprising:
updating a current master data sheet based on the change in the display data, the current master data sheet comprising data fields associated with the display data; and
determining a location of a display associated with the change in the display data.

14. The system as claimed in claim 13, wherein the current master data sheet comprises data fields having names that are similar to names of corresponding database data fields.

15. The method as claimed in claim 13, wherein detecting the change in the display data stored in the database comprises:
populating an updated master data sheet with the display data stored in the database; and
comparing the updated master data sheet with a current master data sheet.

16. The method as claimed in claim 13, wherein updating the current master data sheet comprises:
merging the current master data sheet with the updated master data sheet.

17. The method as claimed in claim 13, wherein determining the location of the display associated with the change in the display data comprises:
obtaining the location from a display location field associated with the change in the display data.

18. The method as claimed in claim 13, wherein updating the display template file to reflect the change in the display data comprises:
generating, by the processor, an updated display template file reflecting the change in the display data; and
replacing, by the processor, a current display template file stored at a location accessed by the local display system with the updated display template file.

19. The method as claimed in claim 13, wherein the change to the display data comprises a plurality of changes pertaining to a plurality of displays, and the method further comprises:
determining locations for each of the plurality of displays; and
for each display, parsing the updated master data sheet to include entries associated for that display in a separate display template file.

20. The method as claimed in claim 13, wherein detecting a change in a display data comprises:
receiving an updated master data sheet that reflects the change to the display data.

21. The method as claimed in claim 13, further comprising:
locating, by the processor, a display template field name that does not have a corresponding master data sheet field name; and
adding a new display data field to the master data sheet for each location, the new display data field having a name that matches the display template field name.

22. The method as claimed in claim 13, further comprising:
associating a plurality of display template files a display of the local display system, each display template file associated with, and rendered on the display, by the local display system during a display time.

23. A non-transitory computer-readable medium having instructions thereon which, when executed by a processor, perform a method of updating a display device, said method comprising:
detecting a change in display data stored in a database; and
updating a display template file to reflect the change in the display data, the display template file comprising data fields having names that are similar to names of corresponding database data fields, the display template file used by a local display system to render the display data.

24. A non-transitory computer-readable medium having instructions thereon which, when executed by a processor, perform a method of updating a display device, said method comprising:
detecting, by a processor, a change in display data stored in a database;
updating, by the processor, a current master data sheet based on the change in the display data, the current master data sheet comprising data fields associated with the display data;
determining, by the processor, a location of a display associated with the change in the display data; and
updating, by the processor, a display template file to reflect the change in the display data, the display template file used by a local display system to render the display data.

25-28. (canceled)
